(19) United States
(12) Patent Application Publication
(10) Pub. No.: US 2005/0106494 A1
(43) Pub. Date: May 19, 2005

(54) Silicon-containing resist systems with cyclic ketal protecting groups

(75) Inventors: Wu-Song Huang, Poughkeepsie, NY (US); Robert D. Allen, San Jose, CA (US); Marie Angelopoulos, Cortlandt Manor, NY (US); Ranee W. Kwong, Wappingers Falls, NY (US); Ratnam Sooriyakumaran, San Jose, CA (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 10/716,785

(22) Filed: Nov. 19, 2003

(51) Int. Cl. G03C 1/492

(52) U.S. Cl. 430/270.1

(57) ABSTRACT

Inventive silsesquioxane polymers are provided, and photoresist compositions that contain such silsesquioxane polymers are provided in which at least a portion of the silsesquioxane polymer contains fluorinated moieties, and at least a portion of the silisesquioxane polymer contains pendant solubility inhibiting cyclic ketal acid-labile moieties that have low activation energy for acid-catalyzed cleaving. The inventive polymer also contains pendant polar moieties that promote alkaline solubility of the resist in aqueous alkaline solutions. The inventive polymers are particularly useful in positive resist compositions. The invention encompasses methods of using such photoresist compositions in forming a patterned structure on a substrate, and particularly multilayer (e.g. bilayer) photolithographic methods, which methods are capable of producing high resolution images at wavelengths such as 193 nm and 157 nm.

### BACKGROUND OF THE INVENTION

The need to remain cost and performance competitive in the microelectronics industry has caused continually increasing semiconductor device density in integrated circuits. To facilitate the increase in device density, new technologies are constantly needed to allow the minimum feature size of these semiconductor devices to be reduced. This requires high-resolution lithography, the principal technique used in patterning microelectronics circuitry. Over approximately the last 20 years, the industry has migrated to shorter wavelength photolithography as the primary means of scaling the resolution to sustain the progressive demand for smaller features. The wavelength of photolithography has migrated from mid-ultraviolet (MUV) wavelengths (350-450 nm) to deep-UV (DUV) radiation (190-300 nm) and vacuum UV (VUV, 125-160 nm). Likewise the photosensitive materials used in photolithography, known as resists, have evolved. MUV lithography employed diazonaphthoquinone (DNQ) and novolac-based resists. These materials offered high performance but were not extendible to DUV and VUV wavelengths due to their opacity at these shorter wavelengths. In addition, these resists were not of sufficient sensitivity to afford high throughput manufacturing.

In response to the need for new, lower opacity, higher sensitivity materials for DUV imaging, chemically amplified resists (CARs) have been developed (e.g. see Ito et al., U.S. Pat. No. 4,491,628) based on photochemically-generated acid-catalyzed deprotection of an acid-labile polymer or resin. For positive tone CARs, acid labile moieties of the polymer are cleaved by an acid-catalyzed thermolysis reaction that renders the deprotected form of the polymer soluble in a subsequently applied developer, such as an aqueous base. The acid becomes available from a radiation sensitive or photosensitive acid generator component.

The acid-labile polymer is prepared from an alkali-soluble resin which have aqueous-soluble moieties, such as a fluorocarbinol. The alkali-soluble resin is partially protected with acid labile groups such as an acetal, an orthester, a ketal or other protecting groups. The protection converts the soluble hydroxyl group to an insoluble group by converting a large portion of hydrophilic hydroxyl groups to more hydrophobic groups (such as ketal groups), resulting in a drastic decrease in the dissolution rate of the polymer in an aqueous-base developing solution. The extent of inihibition of the polymer to dissolution in the developer depends on the quantity of protecting groups grafted on to the polymer chain. It also depends on the inhibiting characteristics of the protecting groups. A group having lower polarity would have the effect of diminishing the solubility of the polymer in an aqueous alkaline developer. The shape and size of the protecting group would also affect its inibition by means of its ability to block the developer from coming into close contact with the unprotected hydroxyl group for dissolution.

An image of the projected patternwise radiation is formed in the resist film after development, which can then serve as an etch-resistant mask for subsequent pattern transfer steps. The resolution obtained is dependent on the quality of the aerial image and the ability of the resist to maintain that image.

The resolution, R, of an optical projection system such as a lithography stepper is limited by parameters described in Raleigh's equation:
R=kλ/NA,
where λ represents the wavelength of the light source used in the projection system and NA represents the numerical aperture of the projection optics used. “k” represents a factor describing how well a combined lithography system can utilize the theoretical resolution limit in practice and can range from about 0.85 down to about 0.35 for standard exposure systems. The theoretical dimensional limit of equal-sized half-pitch features is one quarter of the wavelength, λ. (k=0.25) when NA=1, as the dose applied to the resist is equal to the square of the intensity, and thus the resolution cannot be modulated by any more than λ/4, or a pitch of λ/2. The resolution attainable with each advancing generation of materials has been extended toward these limits through the use of low k techniques and high numerical aperture tools. For 157 nm lithography, the latest VUV wavelength being developed for manufacturing, and using a very high but potentially manufacturable NA of 0.95, the minimum k factor (i.e. λ/4) equals ˜40 nm. To obtain images below this feature size, either an extension of NA to >1, such as is afforded with immersion lithography, or with a non-diffraction limited, non-optical lithography system, such as the so-called next generation lithography (NGL), are options. The most promising of these NGLs are extreme ultraviolet (EUV, sometimes referred to as soft x-ray) or electron beam lithography (EBL).

As the desired feature size decreases, the resolution capability of many current resists is not sufficient to yield the smaller features. The need to achieve less than 100 nm resolution has prompted a push toward increasing numerical aperture (NA) exposure tools. The higher NA allows for improved resolution of smaller feature sizes, however, the higher NA also reduces the depth of focus of aerial images projected onto the resist film. When the depth of focus is relatively shallow, the thickness of the resist film becomes a factor in achieving proper exposure. Thus, thinner resist films may be required for proper exposure at high resolution, but such films often do not yield acceptable overall performance, especially when considering etch requirements for the underlying substrate.

As the resist film is thinned to account for the higher NA, the resist becomes less suitable as an etch mask against later processing of the underlying semiconductor substrate. For example, since the resist film is thin, variation in thickness becomes more significant and may introduce defects into subsequent devices formed on the substrate. Also, micro-channels often form in the upper portions of a resist layer during transfer of the resist image to the substrate by etching. When the resist layer is thin, the micro-channels may extend to the underlying substrate, rendering the resist less effective as a mask.

In addition, the process latitude of many current resists is not sufficient to consistently produce the smaller desired features within specified tolerances. Some of the process parameters where variance may be difficult to avoid include bake time and temperature, exposure time and source output, aerial image focus, and develop time and temperature. The process latitude of a resist is an indication of how wide such variations can be without resulting in a change in the resolution and/or image profile (i.e., size and/or shape of a resist image). That is, if the process latitude is sufficiently wide, then a process parameter may vary, but the variance will not produce a change in the resist image incompatible with specified tolerances.

Another problem that occurs as feature size decreases and pattern density increases, is that collapsing of such high aspect ratio features in the resist may occur. Thus, a thinner resist layer may be required to minimize image collapse.

One approach that enables the use of higher NA exposure tools as well as a thinner photoresist film is multilayer resist processing. One type of multilayer resist processing uses a bilayer (two layer) imaging scheme by first casting a highly energy absorbing underlayer on the semiconductor substrate then casting a thin, silicon-containing imaging layer (photoresist film) on top of the underlayer. The silicon-containing resist provides good etch selectivity for anisotropic dry etch processing, such as reactive ion etch (RIE) using an oxygen-containing plasma. Next, selected portions of the silicon-containing layer are exposed and developed to remove the unexposed portions of a negative photoresist film or the exposed portions of a positive photoresist film. Generally, the underlayer is highly absorbing at the imaging wavelength and is compatible with the imaging layer. Interactions to be considered include adhesion between the two layers, intermixing, and contamination of the imaging layer by the components of the underlayer. Also, the refractive index of the underlayer is matched to the refractive index of the silicon-containing resist layer to avoid degrading the resolution capability of the silicon-containing resist.

Conventional underlayers include diazonapthoquinone (DNQ)/novolac resist material or novolac resin cast on the semiconductor substrate. The underlayers are typically selected to have good selectivity for an anisotropic etch, and to be sufficiently rigid to minimize feature collapse.

For the imaging layer, resists containing a wide variety of silicon-containing polymers have been used, including silsesquioxane, silicon-containing acrylics, silanes, etc. Among the several possible silicon-containing polymers, aqueous base-soluble silsesquioxane polymers, such as poly(p-hydroxybenzylsilsesquioxane) (PHBS), have emerged as the most promising candidates for silicon-containing polymers in bilayer resist systems. Unfortunately, although promising, phenolic polymers, such as PHBS, have transparency limitations. The phenolic polymers used in 365 nm and 248 nm wavelength lithographic processes do not provide sufficient transparency for 193 nm and 157 nm lithographic processes to produce vertical profiles on the resist images. For example, prior art phenolic polymers have extremely high absorption in the range of 10 μm⁻¹ at 193 nm. Newer polymers have been investigated, including the use of bi- and tri-cyclic structures and fluoroalkyl moieties to improve transparency at 193 nm and 157 nm wavelengths.

A phenomenon known as image blur diminishes the integrity of the pattern (Hinsberg et al., Proc. SPIE, 2000, 3999, 148 and Houle et al., J. Vac. Sci. Technol B, 2000, 18, 1874). Image blur can be defined as the deviation of the developable image from that of projected aerial image which is transferred into the film as the concentration of photochemically generated acid. While accelerating the rate of the deprotection reaction, the application of thermal energy diminishes the fidelity of the aerial image of acid formed during the patternwise exposure. Image blur can be divided into two contributing factors: gradient-driven acid diffusion and reaction propagation. Both factors contribute to blur, but to different degrees and with different temperature dependence.

The first factor contributing to image blur is often referred to as acid diffusion and can be described by Fickian diffusion models for solids (Hinsberg, 2000). Choice of the photoacid being generated from the photoacid generator (PAG) and the mobility in the chosen polymer matrix dictate this factor. The mobility in the polymer matrix is dependent on the comprising chemical functionality of the polymer, the free volume of the matrix, the glass transition temperature (T_{g}) of the polymer and the temperature and time of baking steps encountered during the resist processing. Processing at temperatures above T_{g} will tend to increase image blur. Therefore, a higher T_{g} is often desired to avoid blur-inducing film instability. Higher T_{g} is typically achieved by providing longer cyclic chains in the side groups. Although longer cyclic chains tend to decrease the transparency of the resist formulation at the wavelengths of interest, the addition of fluorine in the polymer structures can improve transparency.

A second contributing factor to image blur is sometimes described as reaction propagation (Hinsberg, 2000; Houle, 2000) and is best described by Arhenius behavior. Activation energy (enthalpy, hereinafter referred to as Eₐ), volatility of products (entropy), and the availability and concentration of deprotection-reaction-dependent co-reactants such as moisture dictate the degree to which the reaction propagates away from the original acid profile. Higher Eₐ for the deprotection reaction requires higher baking temperatures, which will tend to increase image blur. Current resists for 193 nm lithography have relatively high Eₐ (i.e. greater than about 20 kcal/mol).

In order to achieve high resolution, high sensitivity and high degree of process latitude, both image blur factors must be eliminated or minimized. Both of these contributing factors can be tempered by the addition of acid-quenchers, or bases, which have been shown to reduce image blur. Additionally it has been recognized that image blur is temperature dependent, and tends to increase as processing temperature increases. Breyta et al. disclose that appropriate baking conditions can optimize the resolution attainable with CARs in U.S. Pat. No. 6,227,546. However, since the extent of thermally induced image blur has been estimated to be on the order of 10-50 nm with conventional resist processing schemes by various researchers (Hinsberg 2000; Houle 2000; Krasnaperova et al., J. Vac. Sci. Technol. B, 1994, 12, 3900; Lin et al, Science 2002, 297, 372), processing that reduces this phenomenon further are desirable.

The use of protecting groups that have low activation energy for the acid-catalyzed cleaving may help reduce image blurring. Low activation energy protecting groups, such as acetal, ketal and orthoesters, have been used. However, prior art low activation protecting groups exhibit the problem that they generate undesirable deprotected species which render process control difficult. For example, chemically amplified photoresist compositions based on acid labile groups comprising acetals often give rise to unpredictable results. In particular, photoresist components comprising an acetal moiety designed to produce a hydroxylic moiety imparting base solubility to the resist typically yield aldehydes upon acid catalyzed cleavage or hydrolysis. In turn, such aldehyde species may lead to resist crosslinking by means of aldol condensation reactions under the influence of heat or radiant energy from the exposing radiation source. Thus, many such acetal based resists unpredictably demonstrate both positive tone and negative tone behaviors. Furthermore, known photoresist compositions based on acetal acid labile groups exhibit a cleavage reaction rate of some nominal value in the exposed regions even at ambient temperature, which reaction rate is accelerated during a PEB step. The cleavage reaction may also continue at a slow rate following PEB and prior to development. If such compositions are processed without the use of a PEB, competing contact reactions or reactions with environmental contaminants slow and interrupt the cleavage reaction prior to completion of acetal cleavage sufficient to render the composition differentially soluble, thus acceptable relief images can not be obtained. If such compositions are processed with the use of a PEB, the degree of completion of the cleavage reaction varies highly depending upon the variation in delay time between the exposure step and the PEB step, and also depending upon the remaining, unconsumed acid present in the resist at the commencement of the PEB step. For these reasons, the results are unpredictable. Thus, there is a need for improved chemically amplified photoresist compositions which are not subject to adverse reactions with environmental contaminants and which are tolerant of variable or lengthy delays between exposure and the post exposure bake step, if any, or between the PEB step and development.

Orthoester protecting groups are relatively highly reactive, and the self life of the resist product would be limited.

Ketal protecting groups typically have higher reaction rates in comparison to acetal systems, for example, up to a thousand times faster. Therefore, the acid catalyzed deprotection reaction may occur at room temperature almost immediately, while the deprotection reaction in acetal systems will require several hours at room temperature, or will require post-exposure bake (PEB). Resist systems using ketal protecting groups may be acid catalyzed without PEB, or at low PEB, and will retain the aerial image without degradation. Since most silsesquioxane (SSQ) systems have a low T_{g}, the use of a ketal protecting group, which has low PEB or no PEB characteristics, provide flexibility in designing the polymer structure and usually enhances the lithographic performance. However, prior art ketal protecting groups are typically linear ketal groups, which have the disadvantages of having low inhibition characteristics and relatively short shelf life.

Thus, there is a need for improved silsesquioxane polymers structures useful in photoresist compositions and in photolithography processes, that have low activation energy for the acid-catalyzed cleaving, as well as improved inhibition of the protected polymer towards a developer, and increased resist shelf life.

### SUMMARY OF INVENTION

It is an objective of the present invention to provide a photoresist or resist composition containing a silisesquioxane polymer that has high resolution.

It is a further objective of the present invention to provide a resist composition that includes a silisesquioxane polymer having cyclic ketal pendant solubility inhibiting acid-labile moieties that have low activation energy for the acid-catalyzed cleaving or deprotection reaction.

It is yet another objective of the present invention to provide a photolithographic method of forming a structure on a substrate that is effective at wavelengths 193 nm and below to provide high resolution transfer of patterned images.

The present invention provides silsesquioxane polymers that are useful in photoresist compositions, and more particularly in positive resist compositions, and photolithographic imaging methods for using such resist compositions. The inventive lithographic imaging methods are particularly useful in the manufacture of integrated circuits or other similarly patterned structures of very high resolution, patterned structures.

Accordingly, the present invention provides a resist composition that includes an acid-sensitive imaging polymer and a radiation-sensitive acid generator, wherein the imaging polymer contains a silsesquioxane backbone and a solubility inhibiting pendant cyclic ketal acid-labile moiety having a low activation energy for acid-catalyzed cleaving, and wherein at least a portion of the imaging polymer is fluorinated.

In another aspect of the present invention, the imaging polymer in the inventive resist composition also includes a pendant solubility promoting moiety.

The present invention is directed to a method of forming a structure on a substrate, including the steps:
(a) providing a substrate;
(b) applying a resist composition to the substrate to form a resist layer on the substrate, wherein the resist composition includes (i) an acid-sensitive imaging polymer, and (ii) a radiation-sensitive acid generator, wherein the imaging polymer contains a silsesquioxane backbone, and a solubility inhibiting pendant cyclic ketal acid-labile moiety having a low activation energy for acid-catalyzed cleaving and wherein at least a portion of the imaging polymer is fluorinated;
(c) patternwise exposing the substrate to radiation, whereby acid is generated by the radiation-sensitive acid generator in exposed regions of the resist layer;
(d) removing patternwise soluble portions of the resist layer to form a pattern of spaces in the resist layer; and
(e) transferring the pattern of spaces to the substrate.

Optionally, the method may also include baking the exposed resist layer to promote an acid-catalyzed reaction in exposed portions of the resist layer subsequent to exposure (post-exposure bake or PEB).

In yet another aspect of the present invention, the lithographic method is a multilayer method, wherein a planarizing layer is formed over the material layer, and the resist layer is applied directly to the planarizing layer.

According to another aspect of the invention, the step of transferring the pattern to the material layer may include any of depositing, plating, implanting or etching the substrate through the pattern of spaces.

The foregoing and other features and advantages of the invention will be apparent from the following detailed description of the invention.

### DETAILED DESCRIPTION OF THE INVENTION

The invention provides new silsesquioxane polymers useful in photoresist or resist compositions, and is particularly useful in positive resist compositions. The invention also encompasses resist compositions containing silsesquioxane polymers mentioned above as well as methods of using such resist compositions in forming a patterned material structure on a substrate. More particularly, the silsesquioxane polymers of the invention comprise an acid labile moiety comprising a cyclic ketal group.

The resist compositions of the invention are characterized in part by the presence of a silsesquioxane polymeric component, where:
(i) at least a portion of the polymeric component contains fluorinated moieties,
(ii) at least a portion of the polymeric component contains pendant acid labile moieties comprising a cyclic ketal, which inhibit solubility of the resist in aqueous alkaline solutions, and
(iii) at least a portion of the polymeric component contains pendant polar moieties which promote alkaline solubility of the resist in aqueous alkaline solutions.

The silsesquioxane polymeric component may have SiO moieties present as part of a polymer backbone or in groups which are pendant from the polymer backbone. Preferably, the SiO moieties form part of a silsesquioxane polymer backbone structure. The silsesquioxane polymeric components preferably contain monomers of the structure: 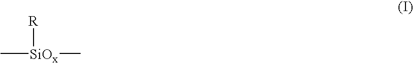
where x is about 1.5, and R is a group (i) at least a portion of which is fluorinated to increase transparency, and contains (ii) a polar moiety which promotes alkaline solubility of the resist in aqueous alkaline solutions, and (iii) an acid labile moiety comprising a cyclic ketal which inhibits solubility of the resist in aqueous alkaline solutions.

Preferred solubility promoting polar moieties preferably include a hydroxyl or carboxylic acid moiety, more preferably a hydroxyl moiety. Solubility promoting moieties in R may include sulfonamide, dicarboxyimide, N-hydroxy dicarboxyimide, any other amino group or any imino group. R may also include fluorinated versions of such solubility promoting moieties.

The solubility inhibiting acid labile cyclic ketal moieties are preferably pendant from the backbone polymer and/or are provided in the polymer matrix as separate dissolution inhibitor molecules containing acid labile moieties. The acid labile cyclic ketal moieties are preferably cleavable in the presence of acid at a temperature at which image blur is minimized or avoided. In a preferred embodiment, the cyclic ketal moieties are cleavable in the presence of acid at room temperature. Preferred cyclic ketal acid labile moieties are those classified as low activation energy (Eₐ) protecting groups (i.e. where Eₐ is less than about 20 kcal/mol).

Applicants have found that polymers protected with cyclic ketal moieties have better inhibition of dissolution in an aqueous developer, such as an aqueous solution of tetramethyl ammonium hydroxide (TMAH), than those protected with linear ketals. For example, a polyhydroxystyrene containing 10% cyclohexanol units with a weight average molecular weight Mw≈5700 was protected with 15% and 20% methoxypropene yielded polymers with dissolution rates of 215 Å/s and 115 Å/s, respectively, in 0.263N TMAH developer. The same polymer was protected with 17% and 18.5% methoxycyclohexene to yield polymers with dissolution rates of 3.8 Å/s and 2.3 Å/s respectively. Without intending to limit the present invention, it is believed that cyclic ketals have lower polarity than linear ketals, and thus the use of cyclic ketal protecting groups would have improved inhibition of polymer solubility in an aqueous alkaline developer compared to polymers using linear ketal protecting groups. Since size and shape of protecting groups also affect solubility inhibition by their relative capability to block unprotected hydroxyl groups from contact with the developer. Thus, it is believed that the shape of cyclic ketals will tend to block developer molecules, such as TMAH base ions, more efficiently than would linear ketal protecting groups.

Cyclic ketal protecting groups of the present invention may comprise structures of the form: 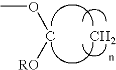
where n is any integer from 2 to 15, and R is an alkyl or halogenated alkyl.

Examples of preferred cyclic ketal protecting groups include, but are not limited to, unsubstituted cyclic aliphatic ketals that satisfy the above formula and thus can be employed in the present invention include:
methoxycyclopropanyl, ethoxycyclopropanyl, butoxycyclohexanyl, methoxycyclobutanyl, ethoxycyclobutanyl, methoxycyclopentanyl, ethoxycyclopentanyl, methoxycyclohexanyl, ethoxycyclohexanyl, propoxycyclohexanyl, methoxycycloheptanyl, methoxycyclooctanyl, methoxynorbornyl, methoxyadamantyl and the like. Of these unsubstituted cyclic aliphatic ketals, it is highly preferred that methoxycyclohexanyl (MOCH) be employed as the acid labile protecting group of the aqueous base soluble polymer or copolymer.

An oxygen atom may also be present within the cyclic ketal structure as long as two oxygen atoms are attached to the same carbon, which then forms a cyclic aliphatic ketal structure of the form:

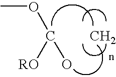

When the hydrogen of the cycloaliphatic portions of the ketal substituent is substituted, it may be substituted with halogens and/or with hydrophobic groups, so-called etch resistance groups or combinations or mixtures thereof. Examples of hydrophobic groups that can be employed in the present invention are halogen-containing groups such as —CF₃, —CHF₂, —CH₂F, —CCl₃, —CHCl₂ and —CH₂Cl, and silicon-containing groups such as —Si(CH₃)₃. When an etch resistance group is employed, the hydrogen of the cycloaliphatic group may be substituted with one or more of the following: metal-containing groups such as Sn, Ti or Zn, and/or large bicyclic, tricyclic or other multicyclic groups containing from about 6 to about 25 carbon atoms.

As stated above, some, but not all, of the initial hydroxyl or carboxylate functional groups of the aqueous base soluble polymer or copolymer are protected with said cyclic aliphatic ketal substituent. Typically, the aqueous base soluble polymer contains from about 5 to about 95 mol % of said cyclic aliphatic ketal protecting group and the remainder being the initial, unprotected functional groups of the aqueous base soluble polymer or copolymer. More preferably, the aqueous base soluble polymer employed in the present invention contains from about 10 to about 50 mol % of said cyclic aliphatic ketal protecting group.

The silsesquioxane polymer preferably contains a combination of such monomers (I) having different R groups selected from (a)-(b). Thus, the silsesquioxane polymer of the present invention preferably contains one or more monomers selected from the group consisting of: 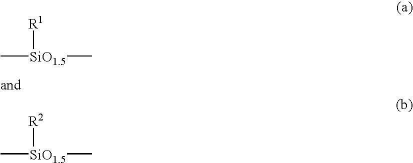
where R¹ contains a polar moiety that promotes alkaline solubility of the resist in aqueous alkaline solutions, and R² contains a cyclic ketal acid labile moiety that inhibits solubility of the resist in aqueous alkaline solutions. The silsesquioxane polymer preferably contains a combination of monomers (a) and (b). Preferably at least a portion of the silsesquioxane polymer is fluorinated, which may include at least a fluorinated portion of monomers (a) and/or (b).

The novel silsesquioxane polymers of the invention preferably includes a combination of monomeric units (II) and (III) described by the formulas: 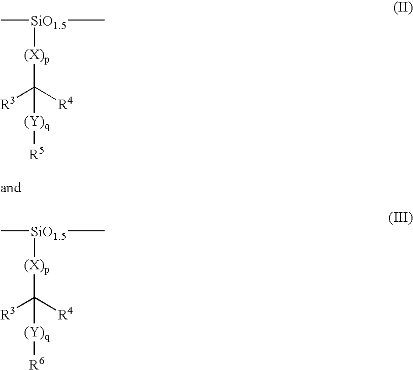
in which:
each R³ is independently selected from any of a hydrogen atom, a halogen atom (preferably fluorine), a linear or branched alkyl, a cycloalkyl, a halogenated linear or branched alkyl (preferably a fluoroalkyl), a halogenated cycloalkyl (preferably a fluorocycloalkyl), an aryl, a halogenated aryl (preferably a fluoroaryl), or any combination thereof, and R³ may optionally further include any of oxygen, sulfur or nitrogen;
each X is independently selected from any one of an oxygen atom, a sulfur atom, NR³, a linear or branched alkyl, a cycloalkyl group, a linear or a branched halogenated alkyl (preferably a fluoroalkyl), a halogenated cycloalkyl (preferably a fluorocycloalkyl), an aryl group, a halogenated aryl (preferably a fluoroaryl), wherein p is an integer having the value 1 or 0 (i.e. including a single bond between a silicon atom of the silsesquioxane group and a carbon atom of a side group);
each Y is independently selected from any one of a linear or branched alkyl, a cycloalkyl group, a linear or branched halogenated alkyl (preferably a fluoroalkyl), a halogenated cycloalkyl (preferably a fluorocycloalkyl), an aryl group, a halogenated aryl (preferably a fluoroaryl), wherein q is an integer having the value 1 or 0 (i.e. R³, R⁴, R⁵ bonded to the same carbon atom);
each R⁴ is independently selected from any of fluorine, linear or branched fluoroalkyl, fluorocycloalkyl, fluoroaryl, or any combination thereof, and R⁴ may optionally further include any of oxygen, sulfur or nitrogen, or any combination thereof; and
R⁶ represents an independently selected solubility promoting group. The solubility promoting group is preferably a hydroxyl or coboxylic acid moiety, more preferably a hydroxyl moiety, such as a fluoroalcohol. The solubility promoting group may also be an imino group or an amino group, including, but not limited to sulfonamide, dicarboxyimide, N-hydroxy dicarboxyimide phenol, or fluorinated versions thereof.

R⁵ represents an independently selected solubility inhibiting group comprising a cyclic ketal which can be formed as a part of a pendant group from the silsesquioxane structure. The cyclic ketal solubility inhibiting group may include fluorinated versions thereof.

The novel silsesquioxane polymers of the invention may also preferably contain a combination of monomeric units (III) and (IV) or units (II) and (V), where the units (IV) and (V) are described by the formulas:

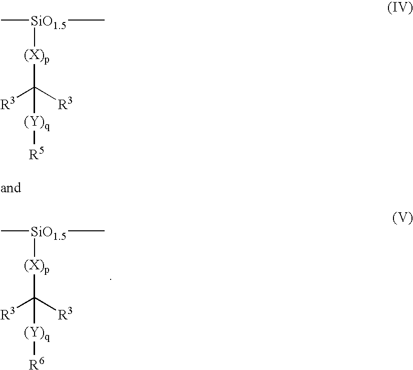

The novel FSQ polymers of the invention preferably have a weight average molecular weight of about 800 to 500,000, more preferably about 1,500 to 100,000, and most preferably about 1,500 to 10,000.

The properties of interest in this regard include solubility in aqueous alkaline developers and a glass transition temperature (T_{g}) that is compatible with normal thermal processing, such as post-apply bake (PAB) and post-exposure bake (PEB). The T_{g} is preferably between 30 and 400° C., more preferably between 50 and 300° C., and most preferably between 70 and 250° C. These properties are discussed further below in the discussion of resist compositions.

The radiation-sensitive or photosensitive acid generators (PAGs) used in the resist compositions of the invention may be any suitable photosensitive acid generator known in the photoresist art, which is otherwise compatible with the other selected components of the resist composition, and in particular, for positive resist compositions. Examples of preferred photosensitive acid generators (PAG) include: -trifluoromethylsulfonyloxy)-bicyclo[2.2.1]hept-5-ene-2,3-dicarboximide (“MDT”), onium salts, aromatic diazonium salts, sulfonium salts, diaryliodonium salts and sulfonic acid esters of N-hydroxyamides or -imides, as disclosed in U.S. Pat. No. 4,731,605. Also, a PAG that produces a weaker acid such as dodecane sulfonate of N-hydroxy-naphthalimide (“DDSN”) may be used. Fluorinated PAG is also preferred for better transparency at 157 nm. Another example of a preferred PAG includes a PAG containing a structure having the formula 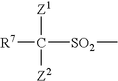
where R⁷ is a monovalent organic group with a fluorine content of 50 wt % or less, a nitro group, a cyano group, or a hydrogen atom, and Z¹ and Z² are individually a fluorine atom or a linear or branched perfluoroalkyl group having 1-10 carbon atoms, as described in U.S. Published Patent Application No. U.S. 2003/0113658 A1, published Jun. 19, 2003, the disclosure of which is incorporated by reference. Combinations of PAGs may be used.

In addition to the above components, the resist compositions of the invention generally include a casting solvent to dissolve the other components so that the overall composition may be applied evenly on the substrate surface to provide a defect-free coating. Where the resist composition is used in a multilayer imaging process, the solvent used in the imaging layer resist is preferably not a solvent to the underlayer materials, otherwise the unwanted intermixing may occur. When the underlayer composition uses a crosslinker approach, a cross-linked underlayer will prevent intermixing. In this case, the same or a different solvent can be used for both the imaging layer and the underlayer. Examples of suitable casting solvents include: ethoxyethylpropionate (“EEP”), a combination of EEP and γ-butyrolactone (“GBL”), propylene-glycohnonoethylether acetate (PGMEA), and ethyl lactate. The invention is not limited to selection of any particular solvent.

The photoresist compositions may further include organic base additives, surfactants, sensitizers or other expedients known in the art. The compositions of the present invention are not limited to any specific selection of these expedients.

Examples of base additives include: dimethylamino pyridine, 7-diethylamino-4-methyl coumarin (“Coumarin 1”), tertiary amines, imidazoles, imides, amides, proton sponge, berberine, and the polymeric amines as in the PLURONIC® or TETRONIC® series from BASF. Tetra alkyl ammonium hydroxides or cetyltrimethyl ammonium hydroxide may be used as a base additive when the PAG is an onium salt.

Examples of possible surfactants include fluorine-containing surfactants such as the FLUORAD™ series, preferably FC-430, and more preferably, FC-4430, both available from 3M Company in St. Paul, Minn., and siloxane-containing surfactants such as the SILWET® series available from Union Carbide Corporation in Danbury, Conn.

The resist compositions of the invention are not limited to any specific proportions of the various components. The resist composition of the present invention preferably includes about 0.1-25 wt. % PAG, more preferably about 0.5-15 wt. %, based on the total weight of imaging polymer in the composition. The inventive resist composition preferably contains about 0.02-8 wt. % of the base additive, more preferably about 0.1-2 wt. %, based on the total weight of acid sensitive polymer. Where the resist compositions of the invention contain a solvent, the overall composition preferably contains about 50-98 wt. % solvent.

The resist compositions of the invention are useful in single layer photolithographic processes, and are especially useful as imaging layers in multilayer photolithographic processes, such as bi-layer or tri-layer processes. Preferably, the resist compositions of the invention may be patterned using various radiation types such as 365 nm wavelength, deep-UV (specifically 248 nm, and 193 nm wavelengths), extreme-UV (approximately 13 nm wavelength), x-ray, electron beam, and ion beam. The appropriate radiation type(s) may depend on the components of the overall resist composition (e.g., the selection of the polymer component, photosensitive acid generator (PAG), base (or quencher), surfactant, solvent, etc.). The resist compositions of the invention generally provide high resolution (approximately 100 nm resolution or less) in combination with desired dissolution behavior.

The present invention encompasses a single layer method of forming a structure on a substrate, including the steps:
(a) providing a substrate;
(b) applying a resist composition to the substrate to form a resist layer on the substrate, wherein the resist composition includes (i) an acid-sensitive imaging polymer, and (ii) a radiation-sensitive acid generator, wherein the imaging polymer contains a silsesquioxane backbone, and a solubility inhibiting pendant cyclic ketal acid-labile moiety having a low activation energy for acid-catalyzed cleaving and wherein at least a portion of the imaging polymer is fluorinated;
(c) patternwise exposing the substrate to radiation, whereby acid is generated by the radiation-sensitive acid generator in exposed regions of the resist layer;
(d) removing patternwise soluble portions of the resist layer to form a pattern of spaces in the resist layer; and
(e) transferring the pattern of spaces to the substrate.

The exposed resist layer may be baked to promote an acid-catalyzed reaction in the exposed portions of the resist layer.

The substrate may include a material layer to be patterned, and the method may further include a step of transferring the pattern of spaces in the resist layer to the underlying substrate by removing portions of the material layer through the pattern of spaces in the resist layer. Alternatively, the method may include a step of transferring the pattern of spaces in the resist layer to the underlying substrate material (which may include one or more layers of material) by methods including, but not limited to, depositing a material (such as an organic dielectric, a metal, a ceramic or a semiconductor) onto the substrate at the spaces in the resist layer, plating (such as electroless plating or electroplating), or implanting dopants into the substrate material. The substrate may include any suitable material useful in the formation of microelectronic structures, and is preferably selected from any of an organic dielectric, a metal, a ceramic or a semiconductor.

The invention also encompasses a multilayer (e.g. using a bi-layer, tri-layer or other multilayer resist structure) lithography method including the steps of: a) forming a first layer of a planarizing material on a substrate; b) forming a second (imaging) layer of a resist material on the first layer, wherein the second layer includes a resist composition of the invention; c) pattern-wise exposing the second layer to radiation using a patterning tool, optionally followed by post-exposure baking; d) developing a pattern in the second layer to remove unexposed portions of the second layer and to form a patterned resist that reveals portions of the first layer; and e) etching the underlayer through the patterned spaces in the second resist layer to expose the substrate surface. As in a single layer method, the multilayer method may further include transferring the pattern of spaces in the multilayer resist to the underlying substrate by any conventional method such as depositing, implanting, plating or etching.

Preferably, the first layer is a planarizing underlayer that is highly energy absorbing, and/or reduces reflection to the imaging resist layer. The planarizing underlayer is preferably applied directly over the material layer to be patterned. Subsequently, a layer of the inventive resist composition is applied over the first planarizing underlayer, using spin coating or other techniques. The resist coating is preferably as thin as possible provided that the thickness is preferably substantially uniform and that the resist layer is sufficient to withstand subsequent processing (typically reactive ion etching (RIE)) to transfer the lithographic pattern to the planarizing underlayer. Optionally, the substrate with the resist coating may be heated (pre-exposure bake or post-apply bake (PAB)) to remove the solvent and improve the coherence of the resist layer. The PAB step is preferably conducted for about 10 seconds to about 15 minutes, more preferably about 15 seconds to about two minutes. The PAB temperature may vary depending on the T_{g} of the resist.

The resist pattern is then patternwise exposed to the desired radiation. Where scanning particle beams, such as electron beam, are used, patternwise exposure may be achieved by scanning the beam across the substrate and selectively applying the beam in the desired pattern. More typically, wavelike radiation, such as 193 nm or 157 nm UV radiation, is projected through a mask to provide patternwise radiation exposure to the resist. Preferably, the resist image formed in the second layer is a high resolution resist image. Resolution enhancement techniques (RET), such as attenuated phase shift (attPSM), or alternating phase-shift (altPSM) masks or other RET methodologies, may be used as the radiation wavelengths decrease.

Optionally, the patternwise exposed resist layer may be baked (post-exposure bake or PEB) between the exposure and developing steps to further complete the acid-catalyzed reaction, to facilitate the deprotection of acid labile groups in the radiation-exposed portions of the resist layer and to enhance the contrast of the exposed pattern. The PEB is preferably conducted at about 10-175° C., more preferably about 20-120° C. The PEB is preferably conducted for about 30 seconds to 5 minutes.

After post-exposure bake, the resist structure with the desired pattern is obtained (developed as in step (d)) by contacting the resist layer with an alkaline solution that selectively dissolves the areas of the resist which were exposed to radiation. Preferred alkaline solutions (developers) are aqueous solutions of tetramethyl ammonium hydroxide (TMAH). Preferably, the step of developing the second layer uses an aqueous solution of TMAH of about 0.14 N or greater, more preferably about 0.20 N or greater, most preferably about 0.26 N or greater. The resulting lithographic structure on the substrate is then typically dried to remove any remaining developer solvent.

The portions of the first planarizing underlayer are preferably removed (i.e. to remove revealed portions of the first layer using remaining portions of the second layer as a mask) by etching. Preferably, the etching is performed by O₂ plasma reactive ion etching (RIE) or other anisotropic etching techniques. Once the desired portions of the underlayer have been removed, the pattern may be transferred to portions of the substrate, for example, by etching (e.g., by reactive ion etching) the substrate at positions corresponding to the removed portions of the underlayer. Once the desired pattern transfer has taken place, any remaining underlayer and resist may be removed by using conventional stripping techniques.

The planarizing underlayer should be sufficiently etchable, selective to the overlying photoresist (to yield a good profile in the etched underlayer) while being resistant to the etch process needed to pattern the underlying material layer. Additionally, the planarizing underlayer composition should have the desired optical characteristics (e.g., refractive index, optical density, etc.) such that the need for any additional antireflective coating (ARC) layer is avoided. The planarizing underlayer composition should also have physical/chemical compatibility with the imaging resist layer to avoid unwanted interactions which may cause footing and/or scumming. Preferably, the planarizing underlayer compositions are characterized by the presence of (A) a polymer containing: (i) cyclic ether moieties, (ii) saturated polycyclic moieties, and (iii) aromatic moieties for compositions not requiring a separate crosslinker, or (B) a polymer containing: (i) saturated polycyclic moieties, and (ii) aromatic moieties for compositions requiring a separate crosslinker, as described in U.S. Published Patent Application No. U.S. 2002/0058204 A1, published May 16, 2002, the disclosure of which is incorporated herein by reference. Most preferably, a portion of the above-mentioned planarizing underlayer composition further comprises fluorinated polycyclic moieties and/or fluorinated aromatic moieties.

The following examples are provided to further describe the present invention. The invention is not limited to the details of the examples.

### EXAMPLE 1

Comparison of Resists Formulated with Three Different Polymers

Polymer 1. Poly(2-hydroxy-3,3,3-trifluoropropylsilsesquioxane) (FSQ) was partially protected with 40 mole % of methoxycyclohexene (MOCH).

Polymer 2. Poly(2-hydroxy-3,3,3-trifluoropropylsilsesquioxane) (FSQ) was partially protected with 44 mole % of ethyl vinyl ether (EVE).

Polymer 3. Poly[2-hydroxy-3,3,3-trifluoropropylsilsesquioxane-co-5-(2-t-butoxycarbony)norbonylsilsesquioxane] with the following formulation in PGMEA solvent:
3 wt % relative to the polymer TPStTrf (triphenyl sulfonium triflate)
4 wt % relative to the polyer TBAH (tetrabutyl ammonium hydroxide)
200 ppm FLUORAD™ FC-430 surfactant (available from 3M Company).

Resists formulated with polymers 1 and 3 were spin coated on AR40 (from Shipley Company) ARC coated wafers. The films were baked on a hot plate at 110° C. for 1 minute. The exposures were performed on an ASML PAS 5500/1100 tool with an NA of 0.75 using an attPSM mask. After exposure, the resists were baked at 90° C. for 1 minute before being developed with 0.263 N TMAH for 60 s. Images of 90 nm lines with 180 nm pitch were resolved for the resist formulated with polmer 1 but not the resist formulated with polymer 3.

Resists formulated with polymers 1 and 2 were spin coated on HMDS (hexamethyldisilazane) primed wafers. The films were baked on a hot plate at 100° C. (polymer 1 resist) and 110° C. (polymer 2 resist), respectively, for 1 minute. The exposures were performed on a 100 kV Leica exposure system. After exposure, the polymer 1 resist was allowed to sit in the regular lab environment for 30 minutes without PEB. The polymer 2 resist was processed under two conditions: 1) a polymer 2 resist was allowed to sit in the regular lab environment for 30 minutes without PEB; and 2) a polymer 2 resist was baked at 90° C. for 1 minute. Both the polymer 1 and 2 exposed resists were developed with 0.263 N TMAH for 60 s. High resolution of 30 nm I/s images was obtained on polymer 1 resist but not on the polymer 2 resists using either the bake or no bake process.

### EXAMPLE 2

Synthesis of a Fluorinated Cyclic Ketal Protecting Group

A new fluorinated cyclic ketal protecting group with the structure: 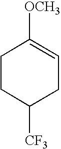
was synthesized using the following synthetic scheme:

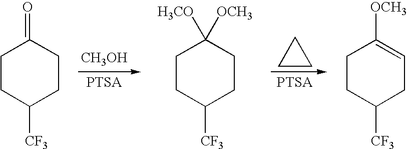

Approximately 5 g of 4-(trifluoromethyl)cyclohexanone was placed in a 25 g flask with 20 mg p-toluenesulfonic acid monohydrate (PTSA) and 10 g of absolute methanol. The flask was then heated up to about 72° C. for 2 days with a heating mantel. The methanol and water were then distilled off at 70° C. with a vacuum pump. Approximately 10 g of absolute methanol was then added into the remaining solution again, and the solution was allowed to reflux at 90° C. for 2½ hours. The methanol was distilled off at 70° C. under vacuum for a few hours. The temperature was then raised to 100° C. to collect the distilled liquid. A nuclear magnetic resonance (NMR) analysis shows the final distilled compound has ˜90% 4-trifluoromethyl-1-methoxycyclohexene and ˜10% of 4-trifluoromethyl-1,1-dimethoxycyclohexane.

### EXAMPLE 3

Synthesis of FSQ with protecting groups of ethoxycyclohexene (EOCH) and methoxypropene (MOP), protected poly(2-hydroxy-3,3,3-trifluoropropylsilsesquioxane), resulting in FSQ protected polymers FSQ-EOCH and FSQ-MOP respectively. Resists were formulated and evaluated with these polymers.

20 wt. % poly(2-hydroxy-3,3,3-trifluoropropylsilsesquioxane) in PGMEA solution was added in with oxalic acid. After the acid was dissolved, the protecting groups were added to the solution, and the reaction was carried out at room temperature with stirring overnight. The quantities of materials used in the synthesis are listed in the Table 1 below. All the reactions were quenched with 1.5 g of Al₂O₃.

TABLE 1

| | FSQ | | | |
|---|---|---|---|---|
| | (20% | | | |
| Polymer | solid) | Protecting group | catalyst | NMR |
| FSQ- | 10 g | 0.85 g | ˜10 mg | 8% protection |
| EOCH | | ethoxycyclohexene | oxalic acid | |
| FSQ- | 12 g | 0.56 g | ˜5 mg oxalic | 15% protection |
| MOP | | methoxypropene | acid | |

Resist formulations were obtained by mixing partially protected polymers (from TABLE 1) with 0.4 wt. % (relative to the polymer) tetrabutyl ammonium hydroxide (TBAH) and 3 wt. % triphenylsulfonium triflate (TPS TRF) and 200-1000 ppm of FLUORAD™ FC-430 surfactant (available from 3M Company) in PGMEA solvent. The total solid weight content in the solution was about 14%. The resists were spin coated on hexamethyldisilazane (HMDS) primed wafers. The films were baked (post-apply bake or PAB) on a hot plate at 90-110° C. for 1 minute.

The exposures were performed at 25 kV on a ElectronCure™-200M tool manufactured by Electron Vision Group. After exposure, resists were either baked at 90-110° C. for 1 minute or rested for 30 minutes without post-exposure bake (PEB) before being developed with 0.26N TMAH for 60-75 s. The following Table 2 lists the dose to clear a large square exposed using resist formulations with different acetal and ketal protected polymers and the corresponding film loss. It shows that a resist formulated with a polymer having only 8% protection with a cyclic ketal has less film loss in comparison to a resist formulated with 15% protection with a linear ketal.

TABLE 2

| Polymer in the resist | | | |
|---|---|---|---|
| formulation | Process conditions | Dose to clear | Film Loss |
| FSQ-EOCH | 1500 rpm, 110° C./60 s | 6 μC/cm² | 503 Å |
| | PAB and NO PEB, | | |
| | 0.26N TMAH 60 s | | |
| FSQ-MOP | 1500 rpm, 90° C./60 s | 8 μC/cm² | 840 Å |
| | PAB and NO PEB, | | |
| | 0.26N TMAH 75 s | | |

While the invention has been particularly shown and described with reference to preferred embodiments thereof, it will be understood by those skilled in the art that various changes in form and details may be made therein without departing from the spirit and scope of the invention.

1. A resist composition, said composition comprising an acid-sensitive imaging polymer including a silsesquioxane backbone and a solubility inhibiting cyclic ketal pendant acid-labile moiety having a low activation energy for acid-catalyzed cleaving, and wherein at least a portion of said imaging polymer is fluorinated.

2. The resist composition of claim 1, further comprising a radiation-sensitive acid generator.

3. The resist composition of claim 1, wherein said imaging polymer further comprises a pendant solubility promoting moiety.

4. The resist composition of claim 3, wherein said pendant solubility promoting moiety is selected from the group consisting of a hydroxyl, a fluoroalcohol, a carboxylic acid, an amino group, an imino group, a fluorinated imino group and a fluorinated amino group.

5. The resist composition of claim 1, wherein at least a portion of said solubility inhibiting pendant cyclic ketal acid-labile moiety is fluorinated.

6. The resist composition of claim 1, wherein said cyclic ketal acid-labile moiety comprises a structure of the form 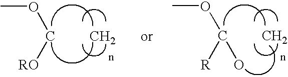
where n is any integer from 2 to 15 and R is an alkyl or a halogenated alkyl.

7. The resist composition of claim 1, wherein said cyclic ketal acid-labile moiety is selected from the group consisting of methoxycyclopropanyl, ethoxycyclopropanyl, butoxycyclohexanyl, methoxycyclobutanyl, ethoxycyclobutanyl, methoxycyclopentanyl, ethoxycyclopentanyl, methoxycyclohexanyl, ethoxycyclohexanyl, propoxycyclohexanyl, methoxycycloheptanyl, methoxycyclooctanyl, methoxynorbornyl and methoxyadamantyl.

8. The resist composition of claim 1, wherein said cyclic ketal acid-labile moiety is substituted.

9. The resist composition of claim 1, wherein said cyclic ketal acid-labile moiety is substituted with fluorine or a hydrophobic moiety selected from the group consisting of —CF₃, —CHF₂, —CH₂F, —CCl₃, —CHCl₂ and —CH₂Cl, and —Si(CH₃)₃.

10. The resist composition of claim 3, wherein at least a portion of said solubility promoting moiety is fluorinated.

11. The resist composition of claim 1, wherein said silsesquioxane polymer has a weight average molecular weight of about 800 to 500,000.

12. The resist composition of claim 1, wherein said imaging polymer comprises a combination of monomeric units (II) and (III) described by the formulas: 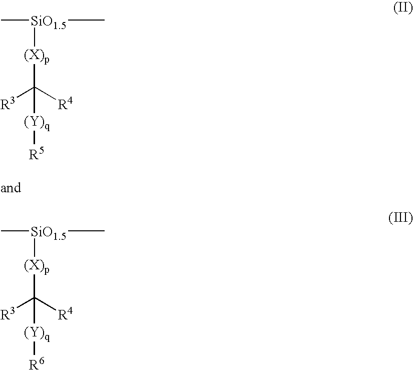
in which
each R³ is independently selected from the group consisting of a hydrogen atom, a halogen atom, a linear alkyl, a branched alkyl, a cycloalkyl, a halogenated linear alkyl, a halogenated branched alkyl, a halogenated cycloalkyl, an aryl, a halogenated aryl, or any combination thereof,
each X is independently selected from the group consisting of an oxygen atom, a sulfur atom, NR³, a linear alkyl, a branched alkyl, a cycloalkyl group, a halogenated linear alkyl, a halogenated branched alkyl, a halogenated cycloalkyl, an aryl group, or a halogenated aryl, wherein p is an integer having the value 1 or 0,
each Y is independently selected from the group consisting of a linear alkyl, a branched alkyl, a cycloalkyl group, a halogenated linear alkyl, a halogenated branched alkyl, a halogenated cycloalkyl, an aryl group, or a halogenated aryl, wherein q is an integer having the value 1 or 0,
each R⁴ is independently selected from the group consisting of a fluorine atom, a fluorinated linear alkyl, a fluorinated branched alkyl, a fluorocycloalkyl, a fluoroaryl, or any combination thereof,
each R⁵ is independently a solubility inhibiting cyclic ketal group, and
each R⁶ is independently a solubility promoting group.

13. The resist composition of claim 1, wherein said imaging polymer comprises a combination of monomeric units (III) and (IV) or units (II) and (V), wherein the monomeric units (II) and (III) are described by the formulas: 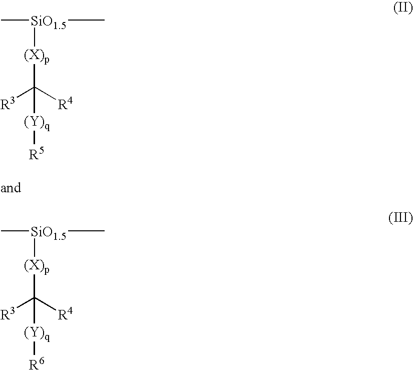
in which
each R³ is independently selected from the group consisting of a hydrogen atom, a halogen atom, a linear alkyl, a branched alkyl, a cycloalkyl, a halogenated linear alkyl, a halogenated branched alkyl, a halogenated cycloalkyl, an aryl, a halogenated aryl, or any combination thereof,
each X is independently selected from the group consisting of an oxygen atom, a sulfur atom, NR³, a linear alkyl, a branched alkyl, a cycloalkyl group, a halogenated linear alkyl, a halogenated branched alkyl, a halogenated cycloalkyl, an aryl group, or a halogenated aryl, wherein p is an integer having the value 1 or 0,
each Y is independently selected from the group consisting of a linear alkyl, a branched alkyl, a cycloalkyl group, a halogenated linear alkyl, a halogenated branched alkyl, a halogenated cycloalkyl, an aryl group, or a halogenated aryl, wherein q is an integer having the value 1 or 0,
each R⁴ is independently selected from the group consisting of a fluorine atom, a fluorinated linear alkyl, fluorinated branched alkyl, a fluorocycloalkyl, a fluoroaryl, or any combination thereof,
each R⁵ is independently a solubility inhibiting cyclic ketal group, and
each R⁶ is independently a solubility promoting group; and
the monomeric units (IV) and (V) are described by the formulas:

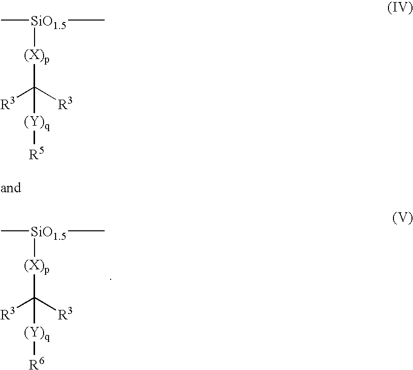

14. A method of forming a structure on a substrate, said method comprising the steps of:
providing a substrate;
applying a resist composition to said substrate to form a resist layer on said substrate, said resist composition comprising an acid-sensitive imaging polymer comprising a silsesquioxane backbone, and a solubility inhibiting pendant cyclic ketal acid-labile moiety having a low activation energy for acid-catalyzed cleaving and wherein at least a portion of said imaging polymer is fluorinated; and
patternwise exposing said substrate to radiation, whereby acid is generated by said radiation-sensitive acid generator in exposed regions of said resist layer;
removing patternwise soluble portions of said resist layer to form a pattern of spaces in said resist layer; and
transferring said pattern of spaces to said substrate.

15. The method of claim 14 further comprising the step of baking the exposed resist layer to promote acid-catalyzed reaction in exposed portions of said resist layer.

16. The method of claim 14 wherein said resist composition further comprises a radiation-sensitive acid generator.

17. The method of claim 14, wherein said polymer further comprises a pendant solubility promoting moiety.

18. The method of claim 17, wherein said pendant solubility promoting moiety is selected from the group consisting of a hydroxyl, a fluoroalcohol, a carboxylic acid, an amino group, an imino group, a fluorinated imino group and a fluorinated amino group.

19. The method of claim 14, wherein at least a portion of said solubility inhibiting pendant cyclic ketal acid-labile moiety is fluorinated.

20. The method of claim 14, wherein said cyclic ketal acid-labile moiety comprises a structure of the form 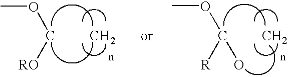
where n is any integer from 2 to 15, and R is an alky or halogenated alkyl.

21. The method of claim 14, wherein said cyclic ketal acid-labile moiety is selected from the group consisting of methoxycyclopropanyl, ethoxycyclopropanyl, butoxycyclohexanyl, methoxycyclobutanyl, ethoxycyclobutanyl, methoxycyclopentanyl, ethoxycyclopentanyl, methoxycyclohexanyl, ethoxycyclohexanyl, propoxycyclohexanyl, methoxycycloheptanyl, methoxycyclooctanyl, methoxynorbornyl and methoxyadamantyl.

22. The method of claim 14, wherein said cyclic ketal acid-labile moiety is substituted.

23. The method of claim 14, wherein said cyclic ketal acid-labile moiety is substituted with fluorine or a hydrophobic moiety selected from the group consisting of —CF₃, —CHF₂, —CH₂F, —CCl₃, —CHCl₂ and —CH₂Cl, and —Si(CH₃)₃.

24. The method of claim 14, wherein said silsesquioxane polymer has a weight average molecular weight of about 800 to 500,000.

25. The method of claim 14, wherein said imaging polymer comprises a combination of monomeric units (II) and (III) described by the formulas: 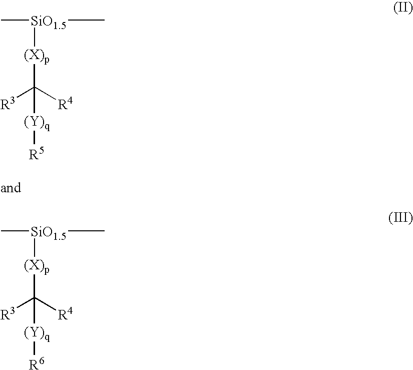
in which
each R³ is independently selected from the group consisting of a hydrogen atom, a halogen atom, a linear alkyl, a branched alkyl, a cycloalkyl, a halogenated linear alkyl, a halogenated branched alkyl, a halogenated cycloalkyl, an aryl, a halogenated aryl, or any combination thereof,
each X is independently selected from the group consisting of an oxygen atom, a sulfur atom, NR³, a linear alkyl, a branched alkyl, a cycloalkyl, a halogenated linear alkyl, a halogenated branched alkyl, a halogenated cycloalkyl, an aryl group, or a halogenated aryl, wherein p is an integer having the value 1 or 0,
each Y is selected from the group consisting of a linear alkyl, a branched alkyl, a cycloalkyl group, a halogenated linear alkyl, a halogenated branched alkyl, a halogenated cycloalkyl, an aryl group, or a halogenated aryl, wherein q is an integer having the value 1 or 0,
each R⁴ is selected from the group consisting of a fluorine atom, a fluorinated linear alkyl, a fluorinated branched alkyl, a fluorocycloalkyl, a fluoroaryl, or any combination thereof,
each R⁵ is independently a cyclic ketal solubility inhibiting group, and
each R⁶ is independently a solubility promoting group.

26. The method of claim 14, wherein said imaging polymer comprises a combination of monomeric units (III) and (IV) or units (II) and (V), wherein the monomeric units (II) and (III) are described by the formulas: 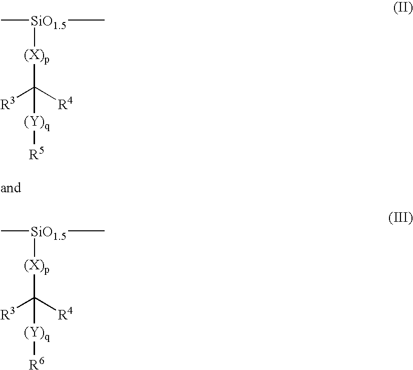
in which
each R³ is independently selected from the group consisting of a hydrogen atom, a halogen atom, a linear alkyl, a branched alkyl, a cycloalkyl, a halogenated linear alkyl, a halogenated branched alkyl, a halogenated cycloalkyl, an aryl, a halogenated aryl, or any combination thereof,
each X is selected from the group consisting of an oxygen atom, a sulfur atom, NR³, a linear alkyl, a branched alkyl, a cycloalkyl group, a halogenated linear alkyl, a halogenated branched alkyl, a halogenated cycloalkyl, an aryl group, or a halogenated aryl, wherein p is an integer having the value 1 or 0,
each Y is selected from the group consisting of a linear alkyl, a branched alkyl, a cycloalkyl group, a halogenated linear alkyl, a halogenated branched alkyl, a halogenated cycloalkyl, an aryl group, or a halogenated aryl, wherein q is an integer having the value 1 or 0,
each R⁴ is independently selected from the group consisting of a fluorine atom, a fluorinated linear alkyl, a fluorinated branched alkyl, a fluorocycloalkyl, a fluoroaryl, or any combination thereof,
each R⁵ is independently a cyclic ketal solubility inhibiting group, and
each R⁶ is independently a solubility promoting group; and
the monomeric units (IV) and (V) are described by the formulas:

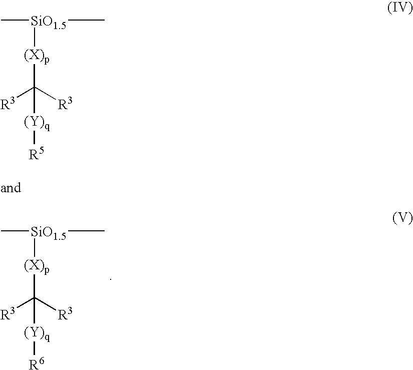

27. The method of claim 14, further comprising forming a planarizing layer over said substrate, wherein said resist layer is applied directly to said planarizing layer, and etching said planarizing layer through said pattern of spaces in said resist layer to expose said substrate.

28. The method of claim 27, wherein said planarizing layer has an underlayer composition comprising:
(A) a polymer containing (i) cyclic ether moieties, (ii) saturated polycyclic moieties, and (iii) aromatic moieties if said underlayer composition does not require a separate crosslinker, or
(B) a polymer containing (i) saturated polycyclic moieties, and (ii) aromatic moieties if said underlayer composition requires a separate crosslinker.

29. The method of claim 28, wherein said underlayer composition further comprises a fluorinated polycyclic moiety, a fluorinated aromatic moiety or a combination thereof.

30. The method of claim 14, wherein said step of transferring further comprises a method selected from the group consisting of depositing, implanting, plating and etching.
